(19) United States
(12) Patent Application Publication
(10) Pub. No.: US 2008/0039999 A1
(43) Pub. Date: Feb. 14, 2008

(54) MULTIMEDIA PLAYING DEVICE WITH A POP-UP INTERFACE MODULE

(76) Inventors: Bing-Yen Lee, Miao-Li City (TW); Hung-Chia Lu, Taoyuan County (TW)

Correspondence Address: NORTH AMERICA INTELLECTUAL PROPERTY CORPORATION, P.O. BOX 506, MERRIFIELD, VA, 22116, US

(21) Appl. No.: 11/734,791

(22) Filed: Apr. 13, 2007

(30) Foreign Application Priority Data
Apr. 26, 2006 (TW) 095114923

(51) Int. Cl. G06F 7/00

(52) U.S. Cl. 701/36

(57) ABSTRACT

A multimedia playing device includes a main body, and a pop-up interface module connected to the main body in a movable manner relative to the main body. The pop-up interface module includes a memory interface for connecting a memory device. When the pop-up interface module is located in a first position, the memory interface is contained inside the main body. When the pop-up interface module is located in a second position, the memory interface protrudes from the main body.

### BACKGROUND OF THE INVENTION

1. Field of the Invention

The present invention relates to a multimedia playing device, and more particularly, to a multimedia playing device with a pop-up interface module.

2. Description of the Prior Art

As technology progresses, electronic components are rapidly applied in automobiles for increasing safety, comfort, entertainment, and so on. An automobile multimedia playing device is a key component of playing multimedia data, such as mp3, VCD, DVD files. Please refer to FIG. 1. FIG. 1 is a schematic drawing of an automobile multimedia playing device 10 in the prior art. An opening 12 is disposed on the automobile multimedia playing device 10 for connecting a memory device 14 externally. The memory device 14 can be a handy drive, such as an USB flash drive. When the memory device 14 is inserted into the opening 12 vertically, the automobile multimedia playing device 10 can play multimedia files stored in the memory device 14 so as to extend the multimedia source of the automobile multimedia playing device 10. However when a vehicle with the automobile multimedia playing device 10 is running and the memory device 14 is inserted into the opening 12 vertically, there is a risk of the memory device 14 piercing the driver while an automobile accident occurs or the vehicle brakes suddenly. It causes danger to the driver and reduces safety of driving the vehicle.

### SUMMARY OF THE INVENTION

It is therefore a primary objective of the claimed invention to provide a multimedia playing device with a pop-up interface module for solving the above-mentioned problem.

According to the claimed invention, a multimedia playing device includes a main body, and a pop-up interface module connected to the main body in a movable manner relative to the main body. The pop-up interface module includes a memory interface for connecting a memory device. When the pop-up interface module is located in a first position, the memory interface is contained inside the main body. When the pop-up interface module is located in a second position, the memory interface protrudes from the main body.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic drawing of an automobile multimedia playing device in the prior art.

FIG. 2 is a schematic drawing of a multimedia playing device of the present invention.

FIG. 3 is a schematic drawing of a pop-up interface module protruding from a main body of the present invention.

FIG. 4 is a back view of the multimedia playing device of the present invention.

FIG. 5 is an exploded diagram of the pop-up interface module of the present invention.

FIG. 6 and FIG. 7 are diagrams of the pop-up interface module at different view angles of the present invention.

FIG. 8 is a diagram illustrating relative positions of the pop-up interface module and the main body when the pop-up interface module is located in a first position and a second position according to a first embodiment of the present invention.

FIG. 9 is a diagram illustrating relative positions of the pop-up interface module and the main body when the pop-up interface module is located in the first position and the second position according to a second embodiment of the present invention.

FIG. 10 is a diagram illustrating relative positions of the pop-up interface module and the main body when the pop-up interface module is located in the first position and the second position according to a third embodiment of the present invention.

FIG. 11 is a schematic drawing of the multimedia playing device according to a fourth embodiment of the present invention.

FIG. 12 is a schematic drawing of the multimedia playing device according to a fifth embodiment of the present invention.

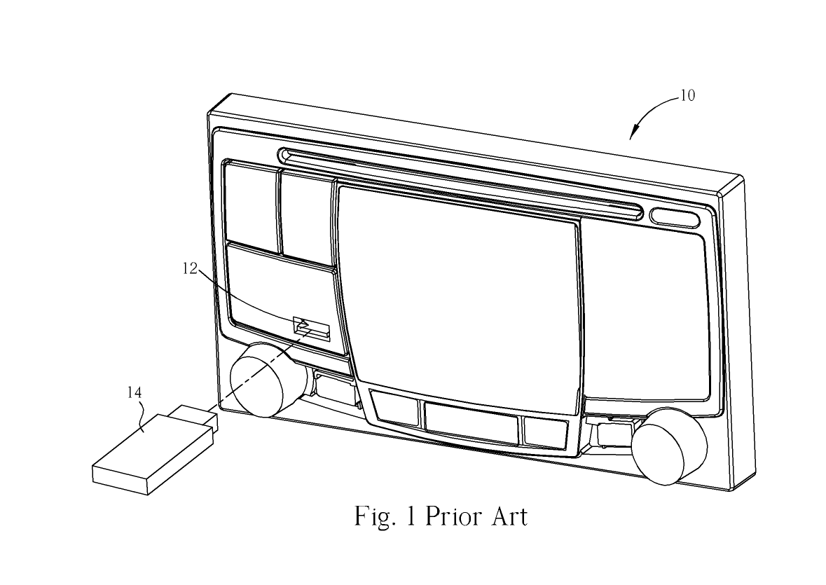

### DETAILED DESCRIPTION

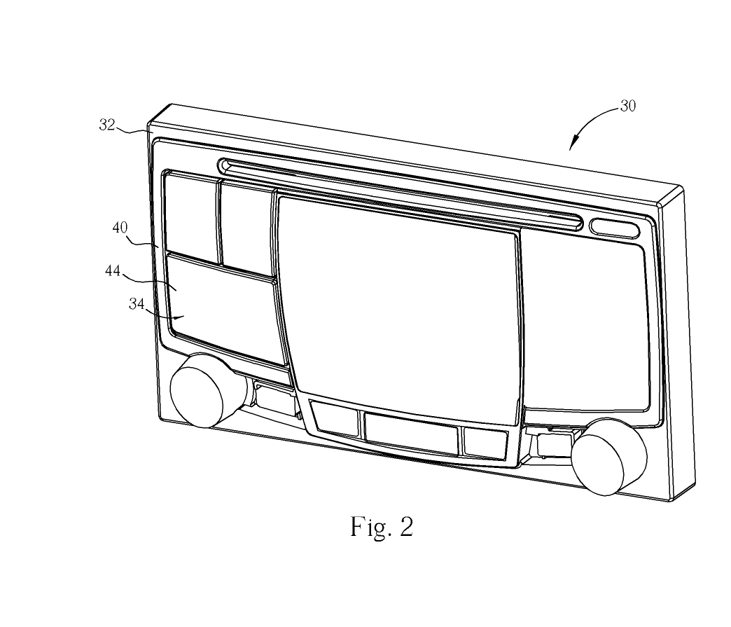

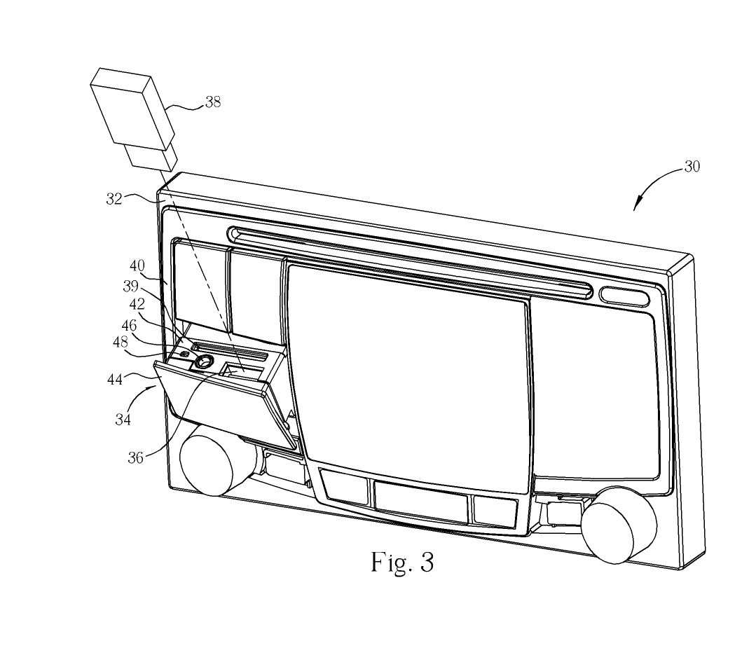

Please refer to FIG. 2. FIG. 2 is a schematic drawing of a multimedia playing device 30 of the present invention. The multimedia playing device 30 can be installed on a vehicle, such as a mobile multimedia playing device, or installed on a household appliance, such as a refrigerator, a television, and so on. The multimedia playing device 30 includes a main body 32, and a pop-up interface module 34 connected to the main body 32 in a movable manner relative to the main body 32. Please refer to FIG. 3. FIG. 3 is a schematic drawing of the pop-up interface module 34 protruding from the main body 32 of the present invention. The pop-up interface module 34 includes a memory interface 36 for connecting a memory device 38. The memory interface 36 can conform to USB interface, and so on. The pop-up interface module 34 further includes a SD card interface 39 for connecting an external SD card. As shown in FIG. 2, when the pop-up interface module 34 is located in a first position, the pop-up interface module 34 does not protrude from the main body 32 so that the memory interface 36 and the SD card interface 39 are contained inside the main body 32. As shown in FIG. 3, when the pop-up interface module 34 is located in a second position, the pop-up interface module 34 protrudes from the main body 32 so that the memory interface 36 and the SD card interface 39 are exploded out of the main body 32 and the user can plug in or pull out the memory device 38 or the external SD card. The main body 32 includes a first surface 40, and the pop-up interface 34 includes a second surface 42 and a third surface 44. The memory interface 36 and the SD card interface 39 are disposed on the second surface 42. When the pop-up interface module 34 is located in the first position shown in FIG. 2, the third surface 44 aligns with the first surface 40 substantially so that the second surface 42 is contained inside the main body 32. When the pop-up interface module 34 is located in the second position shown in FIG. 3, the third surface 44 protrudes from the first surface 40 so that the second surface 42 protrudes from the main body 32 and the user can plug in or pull out the memory device 38 or the external SD card.

In addition, an audio-in interface 46 is further disposed on the second surface 42 of the pop-up interface module 34. When the multimedia playing device 30 is playing a first audio signal, such as a radio signal or a CD audio signal, and the pop-up interface module 34 is located in the second position shown in FIG. 3 and the memory device 38 is connected to the audio-in interface 46, the multimedia playing device 30 stops playing the first audio signal and will play an audio file stored in the memory device 38 automatically. Similarly, when the pop-up interface module 34 is located in the second position shown in FIG. 3 and the memory device 38 is connected to the memory interface 36 or the external SD card is plugged into the SD card interface 39, the multimedia playing device 30 stops playing the first audio signal and will play an audio file stored in the memory device 38 or the external SD card automatically. The memory device 38 can transmit audio signals to the audio-in interface 46 of the multimedia playing device 30 via an audio-out interface of the memory device 38, such as an earphone interface. Then a speaker of the multimedia playing device 30 outputs audio signals transmitted from the memory device 38 directly. When the memory device 38 is connected to the memory interface 36 of the multimedia playing device 30, the multimedia playing device 30 processes multimedia data stored in the memory device 38 and plays the processed multimedia data. A reset button 48 is disposed on the second surface 42 for restoring the multimedia playing device 30 to an initial condition when the multimedia playing device 30 can not work normally.

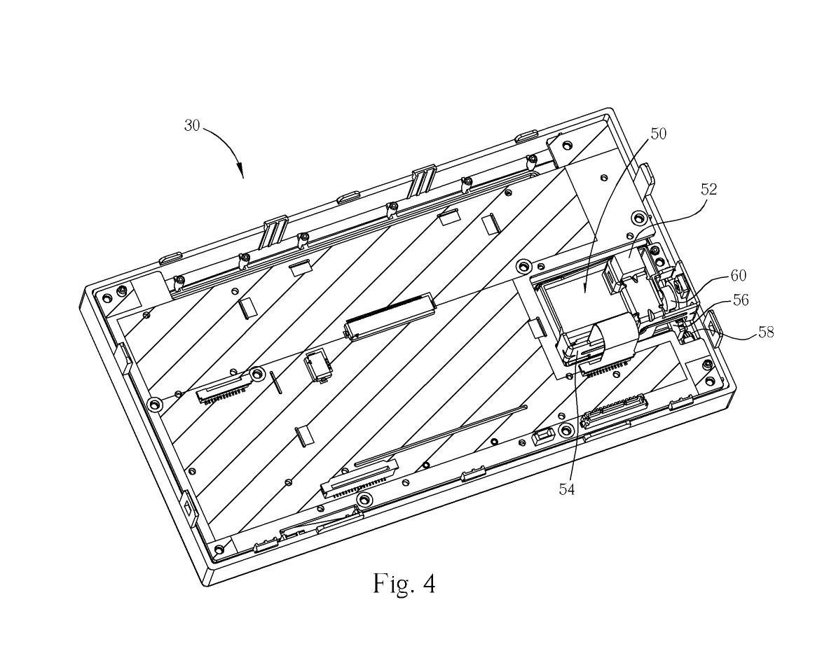

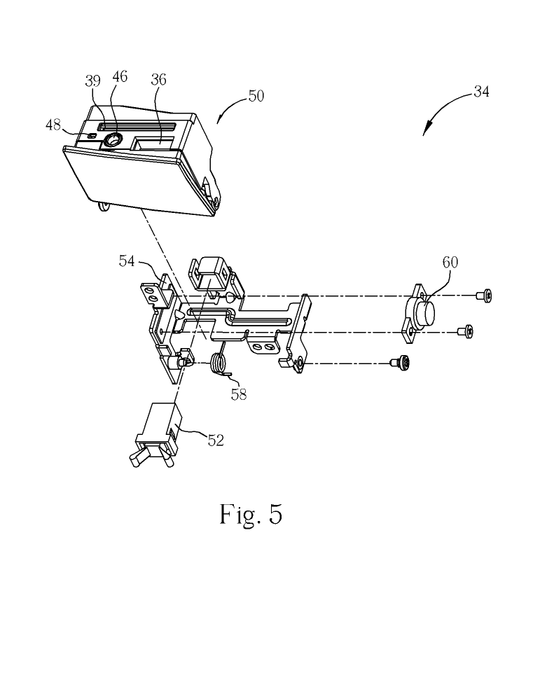

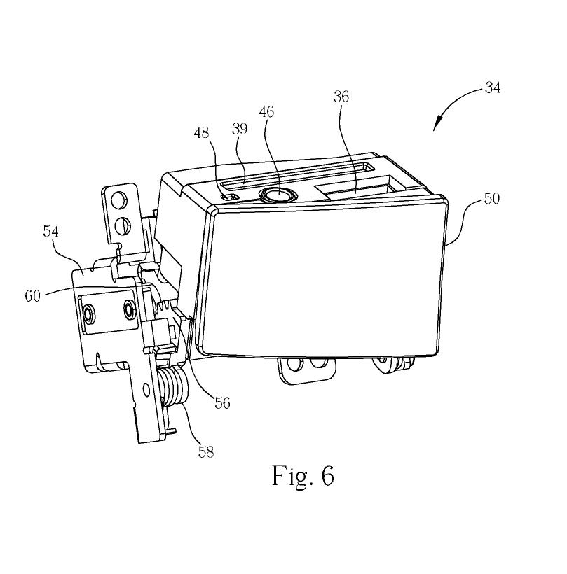

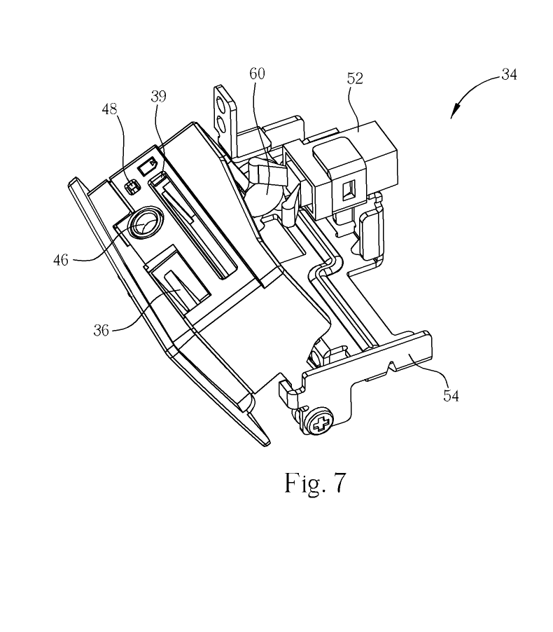

Please refer to FIG. 4 to FIG. 7. FIG. 4 is a back view of the multimedia playing device 30 of the present invention. FIG. 5 is an exploded diagram of the pop-up interface module 34 of the present invention. FIG. 6 and FIG. 7 are diagrams of the pop-up interface module 34 at different view angles of the present invention. The pop-up interface module 34 further includes a cassette base 50. The memory interface 36 is disposed on the cassette base 50. The pop-up interface module 34 further includes a latch 52 for latching the cassette base 50 when the pop-up interface module 34 is located in the first position. The cassette base 50 separates from the latch 52 when the pop-up interface module 34 is located in the second position. The pop-up interface module 34 further includes a frame 54 connected to the main body 32, a gear module 56 fixed to the cassette base 50, and a torsional spring 58. Two ends of the torsional spring 58 are connected to the frame 54 and the cassette base 50 respectively. The pop-up interface module 34 further includes a damping gear 60 engaged with the gear module 56 and connected to the frame 54 in a rotatable manner. When the pop-up interface module 34 is located in the first position shown in FIG. 2, the latch 52 latches the cassette base 50. When the user presses the third surface 44 of the pop-up interface module 34, the cassette base 50 can separate from the latch 52. Then the torsional spring 58 drives the cassette base 50 to rotate relatively to the frame 54 to be at the second position shown in FIG. 3. The damping gear 60 engaged with the gear module 56 can slow down the rotation of the cassette base 50, so the cassette base 50 can open from the first position to the second position slowly.

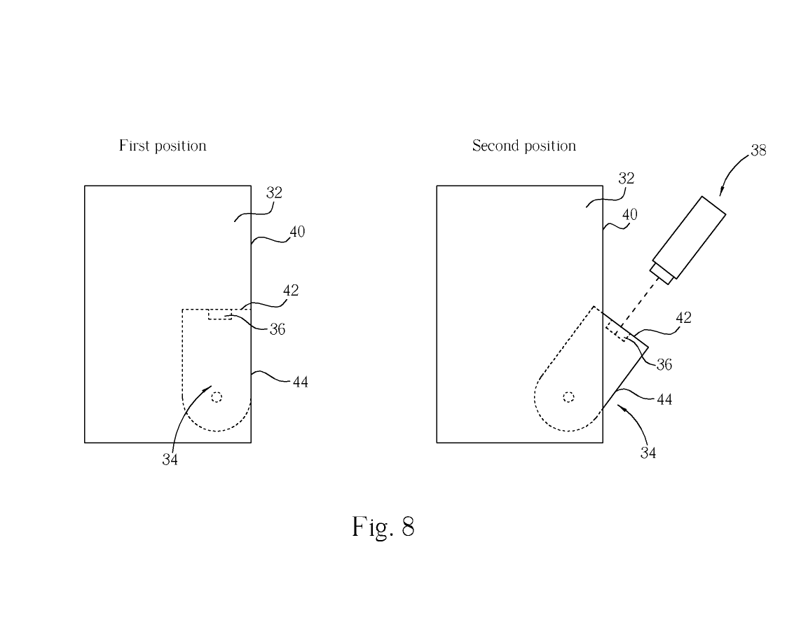

Please refer to FIG. 8. FIG. 8 is a diagram illustrating relative positions of the pop-up interface module 34 and the main body 32 when the pop-up interface module 34 is located in the first position and the second position according to a first embodiment of the present invention. When the pop-up interface module 34 is located in the first position, the third surface 44 aligns with the first surface 40 substantially so that the second surface 42 and the memory interface 36 are contained inside the main body 32. When the pop-up interface module 34 is located in the second position, the third surface 44 protrudes from the first surface 40 so that the second surface 42 and the memory interface 36 protrude from the main body 32. The memory device 38 can be plugged into the memory interface 36 on the second surface 42 obliquely.

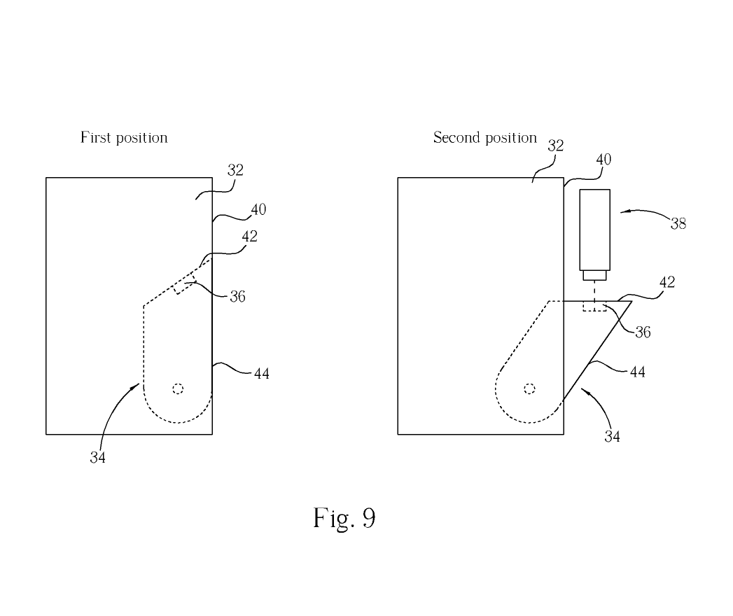

Please refer to FIG. 9. FIG. 9 is a diagram illustrating relative positions of the pop-up interface module 34 and the main body 32 when the pop-up interface module 34 is located in the first position and the second position according to a second embodiment of the present invention. An included angle between the second surface 42 and the third surface 44 is an acute angle. When the pop-up interface module 34 is located in the first position, the third surface 44 aligns with the first surface 40 substantially so that the second surface 42 and the memory interface 36 are contained inside the main body 32. When the pop-up interface module 34 is located in the second position, the third surface 44 protrudes from the first surface 40 so that the second surface 42 and the memory interface 36 protrude from the main body 32. The second surface 42 is perpendicular to the first surface 40 substantially, and the memory device 38 can be plugged into the memory interface 36 on the second surface 42 perpendicularly. That is, when the memory device 38 is connected to the memory interface 36, the memory device 38 is parallel to the first surface 40 substantially.

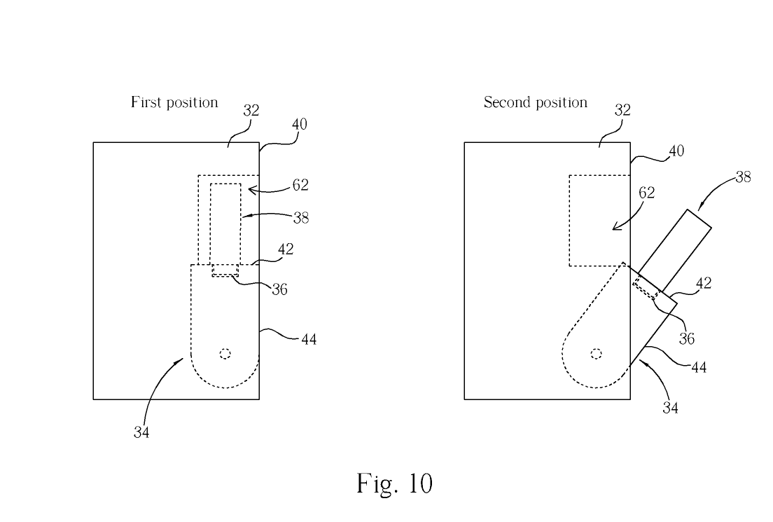

Please refer to FIG. 10. FIG. 10 is a diagram illustrating relative positions of the pop-up interface module 34 and the main body 32 when the pop-up interface module 34 is located in the first position and the second position according to a third embodiment of the present invention. A recess 62 is disposed on the main body 32 and located above the pop-up interface module 34. The memory device 38 is accommodated inside the recess 62 when the pop-up interface module 34 is located in the first position and the memory device 38 is connected to the memory interface 36 on the second surface 42. When the pop-up interface module 34 is located in the second position, the third surface 44 protrudes from the first surface 40 so that the second surface 42 and the memory interface 36 protrude from the main body 32. The memory device 38 can be plugged into the memory interface 36 or pulled out of the memory interface 36. The difference between the third embodiment, the first embodiment, and the second embodiment is that the memory device 38 can be always connected to the memory interface 36 of the third embodiment even when the pop-up interface module 34 is located in the first position and the memory device 36 is contained inside the main body 32.

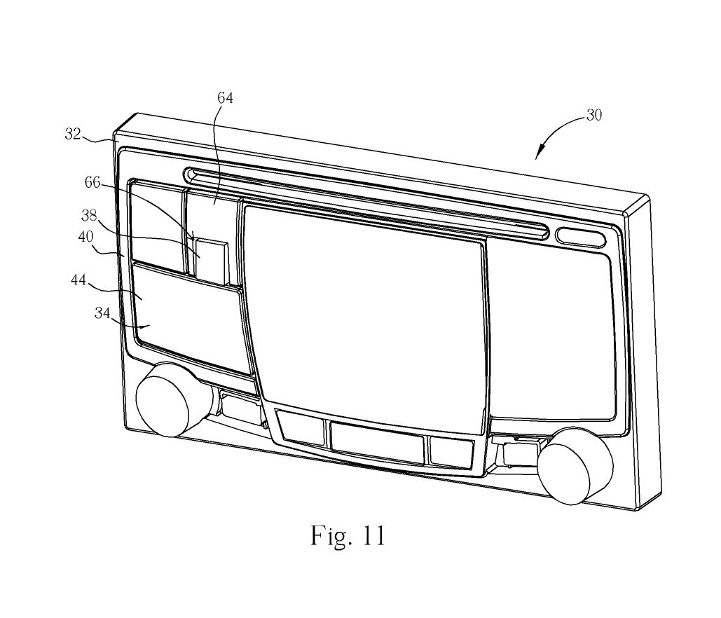

Please refer to FIG. 11. FIG. 11 is a schematic drawing of the multimedia playing device 30 according to a fourth embodiment of the present invention. The main body 32 includes a first button 64 installed above the pop-up interface module 34. A first cavity 66 is disposed on the first button 64. The memory device 38 is accommodated inside the first cavity 66 when the pop-up interface module 34 is located in the first position and the memory device 38 is connected to the memory interface 36. The memory device 38 can be always connected to the memory interface 36 even when the pop-up interface module 34 is located in the first position and the memory device 36 is contained inside the main body 32.

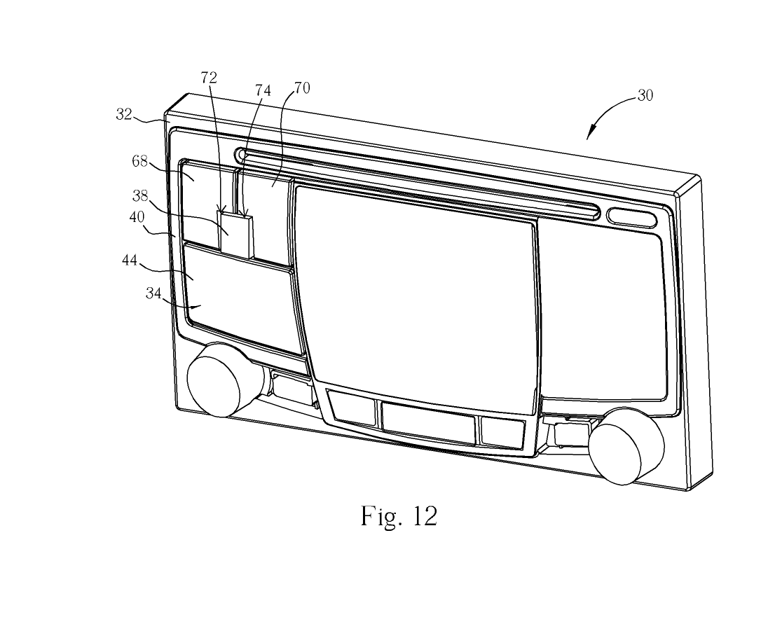

Please refer to FIG. 12. FIG. 12 is a schematic drawing of the multimedia playing device 30 according to a fifth embodiment of the present invention. The main body 32 includes a second button 68 installed on an up-left side of the pop-up interface module 34, and a third button 70 installed on an up-right side of the pop-up interface module 34. A second cavity 72 is disposed on a down-right side of the second button 68, and a third cavity 74 is disposed on a down-left side of the third button 70. The memory device 38 is accommodated inside the second cavity 72 and the third cavity 74 when the pop-up interface module 38 is located in the first position and the memory device 38 is connected to the memory interface 36. The memory device 38 can be always connected to the memory interface 36 even when the pop-up interface module 34 is located in the first position and the memory device 36 is contained inside the main body 32.

In contrast to the conventional multimedia playing device, the multimedia playing device of the present invention provides the pop-up interface module so that the memory interface can be accommodated inside the main body when the user does not remove the memory device and the memory interface protrudes from the main body when the user removes the memory device. It can economize the space. Furthermore, the memory device is connected to the memory interface of the pop-up interface module obliquely or horizontally to the main body instead of being inserted into the main body perpendicularly. It can prevent that the memory device pierces a driver when a vehicle with the multimedia playing device brakes suddenly. The pop-up interface module can be designed as a shrinking mechanism so that the pop-up interface module shrinks back to the main body when an external force is applied to the pop-up interface module. The present invention can reduce danger of the driver and increase safety of the automobile multimedia playing device.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A multimedia playing device comprising:
a main body; and
a pop-up interface module connected to the main body in a movable manner relative to the main body, the pop-up interface module comprising a memory interface for connecting a memory device;
wherein when the pop-up interface module is located in a first position, the memory interface is contained inside the main body and when the pop-up interface module is located in a second position, the memory interface protrudes from the main body.

2. The multimedia playing device of claim 1 wherein the main body comprises a first surface, the pop-up interface module comprises a second surface and a third surface, the memory interface is disposed on the second surface, when the pop-up interface module is located in the first position, the third surface aligns with the first surface substantially so that the second surface is contained inside the main body, and when the pop-up interface module is located in the second position, the third surface protrudes from the first surface so that the second surface protrudes from the main body.

3. The multimedia playing device of claim 2 wherein an audio-in interface is further disposed on the second surface and when the pop-up interface module is located in the second position and the memory device is connected to the audio-in interface, the multimedia playing device stops playing a first audio signal and plays an audio file stored in the memory device automatically.

4. The multimedia playing device of claim 2 wherein when the pop-up interface module is located in the second position and the memory device is connected to the memory interface, the multimedia playing device stops playing a first audio signal and plays an audio file stored in the memory device automatically.

5. The multimedia playing device of claim 2 wherein an included angle between the second surface and the third surface is an acute angle and the second surface is perpendicular to the first surface substantially when the pop-up interface module is located in the second position.

6. The multimedia playing device of claim 5 wherein when the pop-up interface module is located in the second position and the memory device is connected to the memory interface, the memory device is parallel to the first surface substantially.

7. The multimedia playing device of claim 2 wherein a reset button is disposed on the second surface for restoring the multimedia playing device to an initial condition.

8. The multimedia playing device of claim 2 wherein a recess is disposed on the main body and located above the pop-up interface module and the memory device is accommodated inside the recess when the pop-up interface module is located in the first position and the memory device is connected to the memory interface.

9. The multimedia playing device of claim 1 wherein the main body comprises a first button installed above the pop-up interface module, a first cavity being disposed on the first button, and the memory device is accommodated inside the first cavity when the pop-up interface module is located in the first position and the memory device is connected to the memory interface.

10. The multimedia playing device of claim 1 wherein the main body comprises a second button installed on an up-left side of the pop-up interface module, and a third button installed on an up-right side of the pop-up interface module, a second cavity being disposed on a down-right side of the second button, a third cavity being disposed on a down-left side of the third button, and the memory device is accommodated inside the second cavity and the third cavity when the pop-up interface module is located in the first position and the memory device is connected to the memory interface.

11. The multimedia playing device of claim 1 wherein the pop-up interface module further comprises:
a cassette base, the memory interface being disposed on the cassette base; and
a latch for latching the cassette base when the pop-up interface module is located in the first position wherein the cassette base separates from the latch when the pop-up interface module is located in the second position.

12. The multimedia playing device of claim 11 wherein the pop-up interface module further comprises:
a frame connected to the main body;
a gear module fixed to the cassette base;
a torsional spring, two ends of the torsional spring being connected to the frame and the cassette base respectively; and
a damping gear engaged with the gear module and connected to the frame in a rotatable manner.

13. The multimedia playing device of claim 1 being an automobile multimedia playing device.
